(19) United States
(12) Patent Application Publication
(10) Pub. No.: US 2026/0236344 A1
(43) Pub. Date: Aug. 13, 2026

(54) Reactive Dynamic Read Retry

(71) Applicant: SK hynix Inc., Gyeonggi-do (KR)

(72) Inventors: Fan ZHANG, San Jose, CA (US); Pengfei HUANG, San Jose, CA (US); Haobo WANG, San Jose, CA (US)

(21) Appl. No.: 19/047,639

(22) Filed: Feb. 7, 2025

(51) Int. Cl. G06F 11/10

(52) U.S. Cl. CPC G06F 11/1016; G06F 11/1004; G06F 11/1068

(57) ABSTRACT

A method and associated memory system for operating a memory controller. The method reads the data from the memory using a progression of hard reads of the data; utilizes in the progression a set of hard read retry entries including at least a first hard read retry entry and a second hard read retry entry, each of the hard reads performed with a different hard read bias based on the set of the hard read retry entries; continues the progression until a successful read occurs or for a predetermined number times of unsuccessful hard reads; records a read bias used for the successful read and checksums of all unsuccessful hard reads; and after the successful read, replaces the first hard read retry entry with the read-bias of the successful read.

### BACKGROUND

### 1. Field

Embodiments of the present disclosure relate to memory systems, and method of operating such systems, particularly to the operation of solid state drives.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

The SSD may include flash memory components and a controller which includes the electronics that bridge the flash memory components to the SSD input/output (I/O) interfaces. The SSD controller can include an embedded processor that can execute functional components such as firmware (FW). The SSD functional components are device specific, and in most cases, can be updated.

The two main types of flash memory components are named after the NAND and NOR logic gates. The individual flash memory cells exhibit internal characteristics similar to those of their corresponding gates. The NAND-type flash memory may be written and read in blocks (or pages) which are generally much smaller than the entire memory space. The NOR-type flash memory allows a single machine word (byte) to be written to an erased location or read independently. The NAND-type flash memory operates primarily in memory cards, USB flash drives, solid-state drives, and similar products, for general storage and transfer of data.

NAND flash-based storage devices have been widely adopted because of their faster read/write performance, lower power consumption, and shock proof features. In general, however, they are more expensive compared to hard disk drives (HDD). To bring costs down, NAND flash manufacturers have been pushing the limits of their fabrication processes towards 20 nm and lower, which often leads to a shorter usable lifespan and a decrease in data reliability or Quality of Service.

In this context, embodiments of the present invention arise.

### SUMMARY

Aspects of the present invention include a method for operating a memory controller, where the method reads data from the memory using a progression of hard reads of the data; utilizes in the progression a set of hard read retry entries including at least a first hard read retry entry and a second hard read retry entry, each of the hard reads performed with a different hard read bias based on the set of the hard read retry entries; continues the progression until a successful read occurs or for a predetermined number times of unsuccessful hard reads; records a read bias used for the successful read and checksums of all unsuccessful hard reads; and after the successful read, replaces the first hard read retry entry with the read-bias of the successful read.

Further aspects of the present invention include a memory system comprising a memory device, and a controller configured to read data from the memory using a progression of hard reads of the data; utilize in the progression a set of hard read retry entries including at least a first hard read retry entry and a second hard read retry entry, each of the hard reads performed with a different hard read bias based on the set of the hard read retry entries; continue the progression until a successful read occurs or for a predetermined number times of unsuccessful hard reads; record a read bias used for the successful read and checksums of all unsuccessful hard reads; and after the successful read, replace the first hard read retry entry with the read-bias of the successful read.

Other features, aspects and advantages of the present invention will become clear in view of the following description and accompanying the drawings.

### BRIEF DESCRIPTION OF THE DRAWINGS

FIG. 1 is a block diagram schematically illustrating a memory system in accordance with an embodiment of the present invention.

FIG. 2 is a block diagram illustrating a memory system in accordance with an embodiment of the present invention.

FIG. 3 is a circuit diagram illustrating a memory block of a memory device of a memory system in accordance with an embodiment of the present invention.

FIG. 4 is a diagram of an exemplary memory system in accordance with an embodiment of the present invention.

FIG. 5 is a diagram of an exemplary memory system including different decoders in accordance with an embodiment of the present invention.

FIG. 6 is a depiction of a matrix of a LDPC code.

FIGS. 7A and 7B illustrate a Tanner graph representation of the LDPC code and user bits, check nodes and parity bits.

FIG. 7C is a diagram illustrating distributions of states or program voltage (PV) levels for different types of cells of a memory device.

FIG. 8 is a diagram of a classical hard read policy used to read data from a memory.

FIG. 9 is a diagram of a novel hard read policy in accordance with one embodiment of the present invention used to read data from a memory.

FIG. 10 is a diagram of another novel hard read policy in accordance with one embodiment of the present invention used to read data from a memory.

FIG. 11 is a flowchart depicting a method for operating a memory controller in accordance with one embodiment of the present invention.

### DETAILED DESCRIPTION

Various embodiments are described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrases is not necessarily to the same embodiment(s). Throughout the disclosure, like reference numerals refer to like parts in the figures and embodiments of the present invention.

The invention can be implemented in numerous ways, including as a process; an apparatus; a system; a composition of matter; a computer program product embodied on a computer readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims, and the invention encompasses numerous alternatives, modifications and equivalents. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

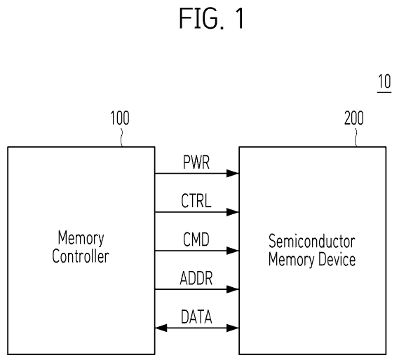

FIG. 1 is a block diagram schematically illustrating a memory system 10 in accordance with an embodiment of the present invention.

Referring FIG. 1, the memory system 10 may include a memory controller 100 and a semiconductor memory device 200, which may represent more than one such device. The semiconductor memory device(s) 200 may be flash memory device(s).

The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output (I/O) lines. The semiconductor memory device 200 may receive power PWR through a power line and a control signal CTRL through a control line. The control signal CTRL may include a command latch enable (CLE) signal, an address latch enable (ALE) signal, a chip enable (CE) signal, a write enable (WE) signal, a read enable (RE) signal, and the like.

The memory controller 100 and the semiconductor memory device 200 may be integrated in a single semiconductor device such as a solid state drive (SSD). The SSD may include a storage device for storing data therein. When the semiconductor memory system 10 is used in an SSD, operation speed of a host (not shown) coupled to the memory system 10 may remarkably improve.

The memory controller 100 and the semiconductor memory device 200 may be integrated in a single semiconductor device such as a memory card. For example, the memory controller 100 and the semiconductor memory device 200 may be so integrated to configure a PC card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

In another embodiment, the memory system 10 may be provided as one of various components in an electronic device such as a computer, an ultra-mobile PC (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

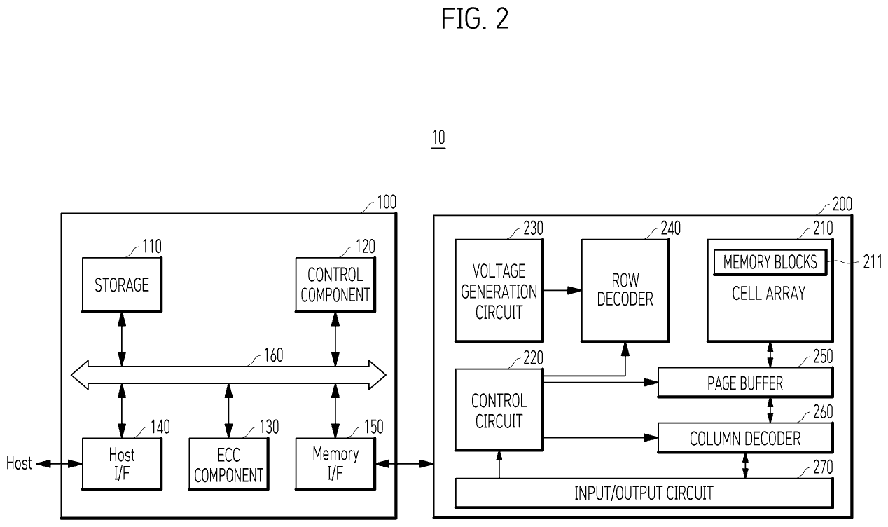

FIG. 2 is a detailed block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device, and in particular, store data to be accessed by the host device.

The host device may be implemented with any one of various kinds of electronic devices. In some embodiments, the host device may include an electronic device such as a desktop computer, a workstation, a three-dimensional (3D) television, a smart television, a digital audio recorder, a digital audio player, a digital picture recorder, a digital picture player, and/or a digital video recorder and a digital video player. In some embodiments, the host device may include a portable electronic device such as a mobile phone, a smart phone, an e-book, an MP3 player, a portable multimedia player (PMP), and/or a portable game player.

The memory device 200 may store data to be accessed by the host device.

The memory device 200 may be implemented with a volatile memory device such as a dynamic random access memory (DRAM) and/or a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as a central processing unit (CPU), an error correction code (ECC) component 130, a host interface (I/F) 140 and a memory interface (I/F) 150, which are coupled through a bus 160.

The storage 110 may serve as a working memory of the memory system 10 and the controller 100, and store data for driving the memory system 10 and the controller 100. When the controller 100 controls operations of the memory device 200, the storage 110 may store data used by the controller 100 and the memory device 200 for such operations as read, write, program and erase operations.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 may control general operations of the memory system 10, and a write operation or a read operation for the memory device 200, in response to a write request or a read request from the host device. The control component 120 may drive firmware, which is referred to as a flash translation layer (FTL), to control general operations of the memory system 10. For example, the FTL may perform operations such as logical-to-physical (L2P) mapping, wear leveling, garbage collection, and/or bad block handling. The L2P mapping is known as logical block addressing (LBA).

The ECC component 130 may detect and correct errors in the data read from the memory device 200 during the read operation. The ECC component 130 may not correct error bits when the number of the error bits is greater than or equal to a threshold number of correctable error bits, and instead may output an error correction fail signal indicating failure in correcting the error bits.

The ECC component 130 may perform an error correction operation based on a coded modulation such as a low-density parity-check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM). As such, the ECC component 130 may include all circuits, systems or devices for suitable error correction operation.

The host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the CPU 120. When the memory device 200 is a flash memory such as a NAND flash memory, the memory interface 150 may generate control signals for the memory and process data under the control of the CPU 120.

The memory device 200 may include a memory cell array 210, a control circuit 220, a voltage generation circuit 230, a row decoder 240, a page buffer 250, which may be in the form of an array of page buffers, a column decoder 260, and an input/output circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages of various levels. For example, in an erase operation, the voltage generation circuit 230 may generate operation voltages of various levels such as an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address RADD generated by the control circuit 220, and transmit operation voltages supplied from the voltage generation circuit 230 to the selected memory blocks.

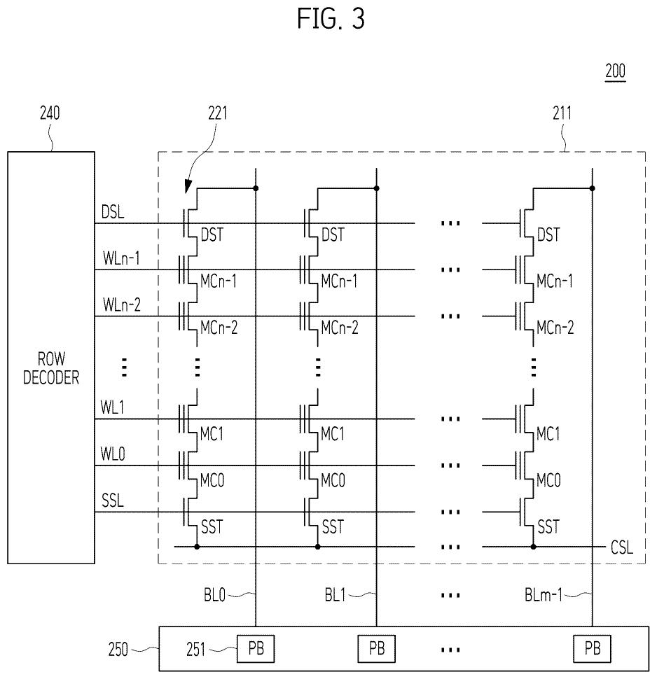

The page buffer 250 may be in electrical communication with the memory cell array 210 through bit lines BL (shown in FIG. 3). The page buffer 250 may precharge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250 or transmit/receive data to/from the input/output circuit 270.

The input/output circuit 270 may transmit to the control circuit 220 a command and an address, received from an external device (e.g., the memory controller 100), transmit data from the external device to the column decoder 260, or output data from the column decoder 260 to the external device, through the input/output circuit 270.

The control circuit 220 may control the peripheral circuit in response to the command and the address.

FIG. 3 is a circuit diagram illustrating a memory block of a semiconductor memory device in accordance with an embodiment of the present invention. For example, the memory block of FIG. 3 may be any of the memory blocks 211 of the memory cell array 200 shown in FIG. 2.

Referring to FIG. 3, the exemplary memory block 211 may include a plurality of word lines WL0 to WLn-1, a drain select line DSL and a source select line SSL coupled to the row decoder 240. These lines may be arranged in parallel, with the plurality of word lines between the DSL and SSL.

The exemplary memory block 211 may further include a plurality of cell strings 221 respectively coupled to bit lines BL0 to BLm-1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn-1 may be serially coupled between the selection transistors DST and SST. Each of the memory cells may be formed as a multi-level cell (MLC) storing data information of multiple bits.

The source of the SST in each cell string may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array 250 may include a plurality of page buffers 251 that are coupled to the bit lines BL0 to BLm-1. The page buffers 251 may operate in response to page buffer control signals. For example, the page buffers 251 my temporarily store data received through the bit lines BL0 to BLm-1 or sense voltages or currents of the bit lines during a read or verify operation.

In some embodiments, the memory blocks 211 may include a NAND-type flash memory cell. However, the memory blocks 211 are not limited to such cell type, but may include NOR-type flash memory cell(s). Memory cell array 210 may be implemented as a hybrid flash memory in which two or more types of memory cells are combined, or one-NAND flash memory in which a controller is embedded inside a memory chip.

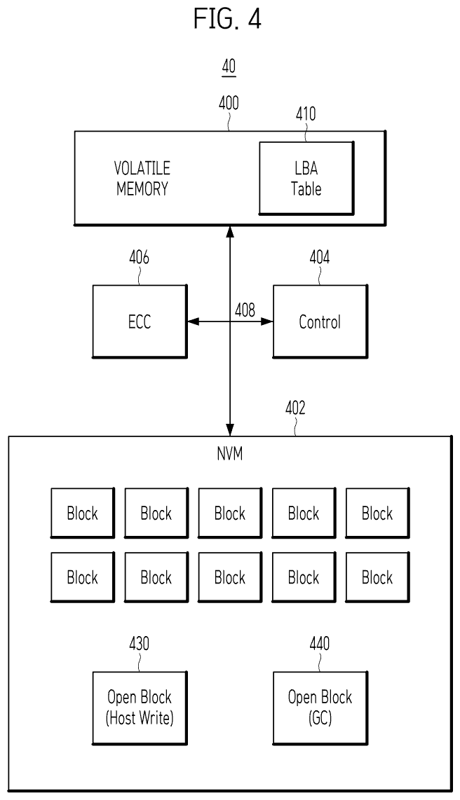

Referring to FIG. 4, a general example of a memory system 40 is schematically illustrated. The memory system 40 may include a volatile memory 400 (e.g., a DRAM), a non-volatile memory (NVM) 402 (e.g., NAND), a control component or control logic 404, such as described herein, an error correcting code (ECC) module 406, such as described herein, and a bus 408 through which these components of the memory system 40 communicate. The volatile memory 400 may include a logical bit address LBA table 410 for mapping physical-to-logical addresses of bits. The NVM 402 may include a plurality of memory blocks (and/or a plurality of super memory blocks), as well as an open block for host writes 430 and an open block for garbage collection (GC) 440. The memory system 40 shows a general memory system. Additional/alternative components that may be utilized with memory systems to effectuate the present invention will be understood to those of skill in the art in light of this disclosure.

As referred to herein, terms such as “NAND” or “NVM” may refer to non-volatile memories such as flash memories which may implement error correcting code processes. Further, “DRAM” may refer to volatile memories which may include components such as controllers and ECC modules.

In embodiments of the present invention, the memory system 10 may include multiple decoders that are configured to decode low-density parity-check (LDPC) codes.

There are many iterative decoding algorithms for LDPC codes, such as bit-flipping (BF) decoding algorithms, belief-propagation (BP) decoding algorithms, sum-product (SP) decoding algorithms, min-sum (MS) decoding algorithms, and Min-Max decoding algorithms.

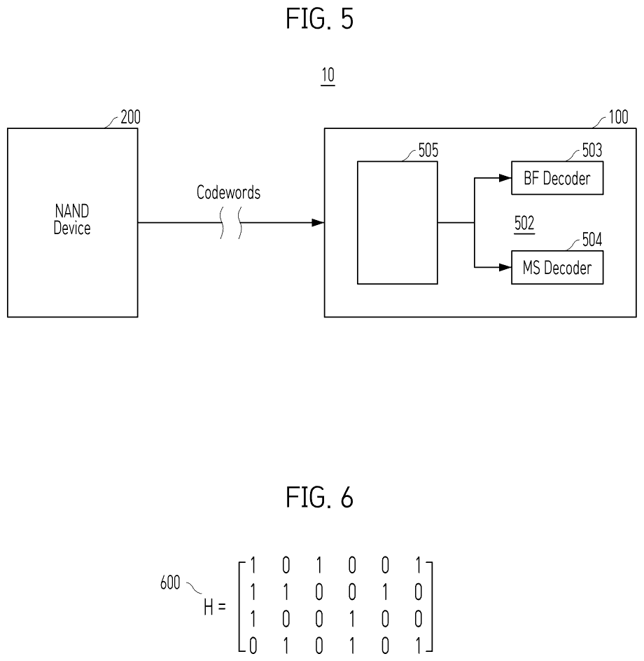

In accordance with embodiments of the present invention, and as shown in FIG. 5, the memory system 10 may include the memory device 200, which may be a NAND device, and the memory controller 100. The memory system 10 may include decoding assembly 502, which includes a bit-flipping (BF) decoder 503 to execute a BF decoding algorithm to decode codewords read from the memory device 200 and a min-sum (MS) decoder 504 to execute an MS decoding algorithm. The BF decoder 503 and the MS decoder 504 may be embodied in the ECC component 130 (shown in FIG. 2) in the memory controller 100 or in any other suitable location. The codewords received from the memory device 200 by the memory controller 100 may be temporarily stored in a buffer or storage 505 of the memory controller 100 before being passed to one or the other of the decoders. In one embodiment of the present invention, the MS decoder 504 is a hybrid precision MS decoder (noted above and described in more detail below).

The memory system 10 may include other components (not shown) such as a checksum module, which computes checksums of codewords retrieved from the memory device 200 before decoding. The checksum module may be embodied within the memory controller 100 before the storage 505. The memory system 10 may further include cyclic redundancy check (CRC) modules disposed downstream of the BF decoder 503 and MS decoder 504, respectively. The CRC modules may be embodied within the memory controller 100.

With respect to the two decoding algorithms, MS decoding, performed by its associated decoder 504, is more powerful due to its higher complexity required to process soft input information. However, the less powerful BF decoding, performed by its associated decoder 503, is useful when the number of errors is low.

MS decoding can be used as part of an iterative LDPC decoding. LDPC codes are linear block codes defined by a sparse parity-check matrix H, which consists of zeros and ones. The term “sparse matrix” is used herein to refer to a matrix in which a number of non-zero values in each column and each row is much less than its dimension. The term “column weight” is used herein to refer to the number of non-zero values in a specific column of the parity-check matrix H. The term “row weight” is used herein to refer to number of non-zero values in a specific row of the parity-check matrix H. In general, if column weights of all of the columns in a parity-check matrix corresponding to an LDPC code are similar, the code is referred to as a “regular” LDPC code. On the other hand, an LDPC code is called “irregular” if at least one of the column weights is different from other column weights. Usually, irregular LDPC codes provide better error correction capability than regular LDPC codes.

LDPC codes are usually represented by bipartite graphs. One set of nodes, the variable or bit nodes correspond to elements of the codeword and the other set of nodes, e.g., check nodes, correspond to the set of parity-check constraints satisfied by the codeword. Typically, the edge connections are chosen at random. The error correction capability of an LDPC code is improved if cycles of short length are avoided in the graph. In a (r,c) regular code, each of the n variable nodes (V1, V2, . . . , Vn) has connections to r check nodes and each of the m check nodes (C1, C2, . . . , Cm) has connections to c bit nodes. In an irregular LDPC code, the check node degree is not uniform. Similarly, the variable node degree is not uniform. In QC-LDPC codes, the parity-check matrix H is structured into blocks of p×p matrices such that a bit in a block participates in only one check equation in the block, and each check equation in the block involves only one bit from the block. In QC-LDPC codes, a cyclic shift of a codeword by p results in another codeword. Here p is the size of square matrix which is either a zero matrix or a circulant matrix. This is a generalization of a cyclic code in which a cyclic shift of a codeword by 1 results in another codeword. The block of p×p matrix can be a zero matrix or cyclically shifted identity matrix of size p×p.

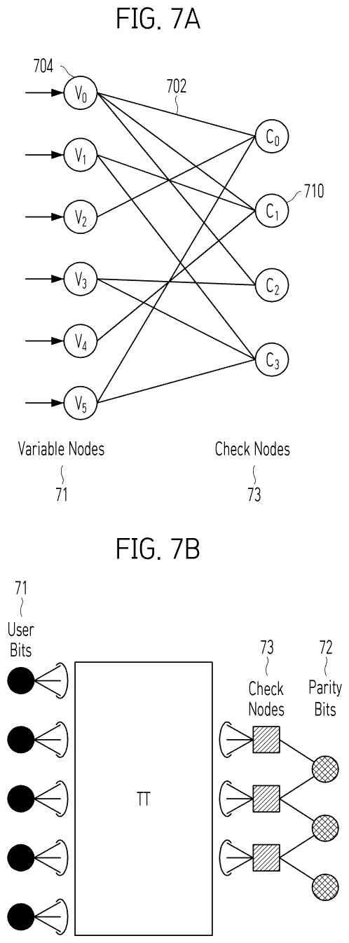

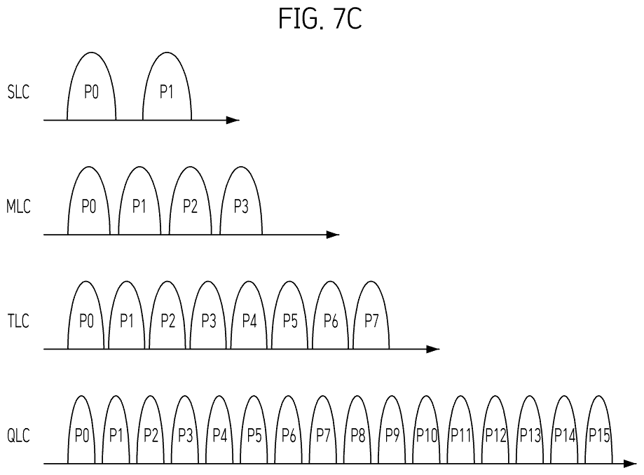

FIG. 6 illustrates an example parity-check matrix H 600, and FIG. 7A illustrates an example bipartite graph corresponding to the parity-check matrix 600.

As shown in FIG. 6, the illustrative parity-check matrix 600 has six column vectors and four row vectors. Network 702 shown in FIG. 7A shows the network corresponding to the parity-check matrix 600 and represent a bipartite graph. Various types of bipartite graphs are possible, including, for example, a Tanner graph. A Tanner graph representation of an LDPC code, with user bits 71, parity bits 72 and check nodes 73, is shown in FIG. 7B.

In general, the variable nodes in network 702 correspond to the column vectors in the parity-check matrix 600. The check nodes in network 702 correspond to the row vectors of the parity-check matrix 600. The interconnections between the nodes are determined by the values of the parity-check matrix 200. Specifically, a “1” indicates the corresponding check node and variable nodes have a connection. A “0” indicates there is no connection. For example, the “1” in the leftmost column vector and the second row vector from the top in the parity-check matrix 600 corresponds to the connection between the variable node 704 and the check node 710.

A message passing algorithm may be used to decode LDPC codes. Several variations of the message passing algorithm exist in the art, such as min-sum (MS) algorithm, sum-product algorithm (SPA) or the like. Message passing uses a network of variable nodes and check nodes, as shown in FIG. 7A.

A hard decision message passing algorithm may be performed. In a first step, each of the variable nodes sends a message to one or more check nodes that are connected to it. In this case, the message is a value that each of the variable nodes believes to be its correct value.

In the second step, each of the check nodes calculates a response to send to the variable nodes that are connected to it using the information that it previously received from the variable nodes. This step can be referred as the check node update (CNU). The response message corresponds to a value that the check node believes that the variable node should have based on the information received from the other variable nodes connected to that check node. This response is calculated using the parity-check equations which force the values of all the variable nodes that are connected to a particular check node to sum up to zero (modulo 2).

At this point, if all the equations at all the check nodes are satisfied, the decoding algorithm declares that a correct codeword is found and it terminates. If a correct codeword is not found, the iterations continue with another update from the variable nodes using the messages that they received from the check nodes to decide if the bit at their position should be a zero or a one by a majority rule. The variable nodes then send this hard decision message to the check nodes that are connected to them. The iterations continue until a correct codeword is found, a certain number of iterations are performed depending on the syndrome of the codeword (e.g., of the decoded codeword), or a maximum number of iterations are performed without finding a correct codeword.

At each iteration of the decoding, the systematic (user) bits 71 and the low-degree parity bits 72 (such as shown in FIG. 7B), may be decoded alternatively. The user bits 71 may be decoded one-by-one using for example MS operations. The low-degree parity bits may be jointly decoded using the results of the user bits 71. The results from the joint decoding may be used for the next iteration.

FIG. 7C is a diagram illustrating distributions of states or program voltage (PV) levels for different types of cells of a memory device.

Referring to FIG. 7C, each of memory cells may be implemented with a specific type of cell, for example, a single level cell (SLC) storing 1 bit of data, a multi-level cell (MLC) storing 2 bits of data, a triple-level cell (TLC) storing 3 bits of data, or a quadruple-level cell (QLC) storing 4 bits of data. Usually, all memory cells in a particular memory device are of the same type, but that is not a requirement.

An SLC may include two states P0 and P1. P0 may indicate an erase state, and P1 may indicate a program state. Since the SLC can be set in one of two different states, each SLC may program or store 1 bit according to a set coding method. An MLC may include four states P0, P1, P2 and P3. Among these states, P0 may indicate an erase state, and P1 to P3 may indicate program states. Since the MLC can be set in one of four different states, each MLC may program or store two bits according to a set coding method. A TLC may include eight states P0 to P7. Among these states, P0 may indicate an erase state, and P1 to P7 may indicate program states. Since the TLC can be set in one of eight different states, each TLC may program or store three bits according to a set coding method. A QLC may include 16 states P0 to P15. Among these states, P0 may indicate an erase state, and P1 to P15 may indicate program states. Since the QLC can be set in one of sixteen different states, each QLC may program or store four bits according to a set coding method.

Referring back to FIGS. 2 and 3, the memory device 200 may include a plurality of memory cells (e.g., NAND flash memory cells). The memory cells are arranged in an array of rows and columns as shown in FIG. 3. The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is asserted. During a read operation, the word line is again asserted, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an MSB page, a center most significant bit (CMSB) page, a center least significant bit (CLSB) page and an LSB page. The memory cells may be programmed using a coding scheme (e.g., Gray coding) in order to increase the capacity of the memory system 10 such as SSD.

During a read operation, the read processor may read data from the memory device 200, which may include some noise or errors, and perform error correction for the read data, as detailed above. Error correction may include use of LDPC decoding, noted above, as well as. bit-flip (BF) decoding and mini-sum (MS) decoding.

Either a soft detector or a hard detector can provide channel information for decoders. For example, a soft detector may output reliability information and a decision for each detected bit. On the other hand, a hard detector may output a hard decision on each bit without providing corresponding reliability information. As an example, a hard detector may output as the hard decision that a particular bit is a “1” or a “0” without indicating how certain or sure the detector is in that decision. In contrast, a soft detector may output a decision and reliability information associated with the decision. In general, reliability information indicates how certain the detector is in a given decision. In one example, a soft detector may output a log-likelihood ratio (LLR) where the sign indicates the decision (e.g., a positive value corresponds to a “1” decision and a negative value corresponds to a “0” decision) and the magnitude indicates how sure or certain the detector is in that decision (e.g., a large magnitude indicates a high reliability or certainty).

### Nand Flash Organization

In an SSD, when a read command is processed, a sequence of read retry entries can be used, each with a different read bias, to read and decode the data. In the deeper stage(s) of defense flow, a threshold voltage (Vt) optimization and soft read/decoding may also be used if the previous steps all fail. In one embodiment of the present disclosure, a memory controller (such as for example memory controller 100 of FIG. 1 or control circuit 220 of FIG. 2) is programmed with a data-reading algorithm to manage the read retry entries for hard reads. In one embodiment, this data-reading algorithm can provide under different NAND conditions optimal quality of service (QoS), even when conditions of the NAND's operation are changing.

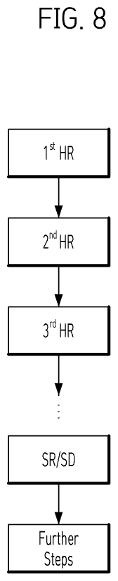

FIG. 8 shows an example of a classical read flow. In FIG. 8, a sequence of hard reads (HR) (e.g., a first HR, a second HR, a third HR, . . . ) is performed to decode a page of data. Each of the hard read retry entry uses a different read-bias to read the page of data. Soft reads/decoding (SR/SD) may be used with a voltage threshold (Vt) optimization algorithm in order to find the optimal center read bias for each NAND state when a set number of hard reads fail.

### Update Policy

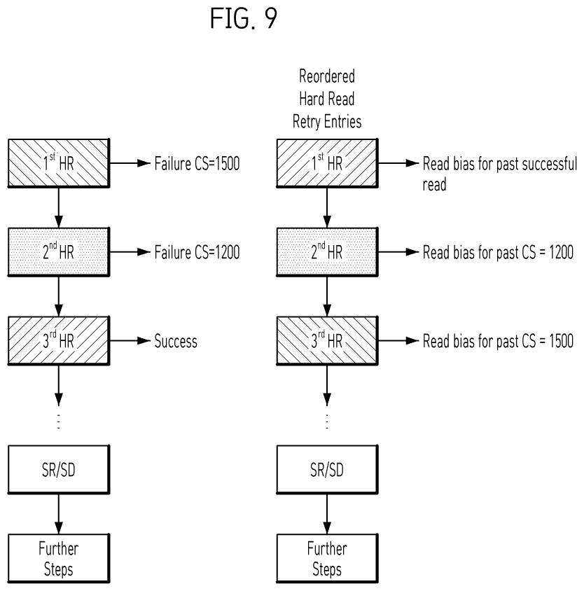

The present inventors have found that the following update policy can better address the changing conditions of a NAND's operation than can be accommodated by the classical read flow noted above. For sake of illustration, assume 7 HRs are used (unsuccessfully) before a soft read is triggered to obtain Vt. The read-biases (used in 1st HR, 2nd HR, . . . 7^{th} HR) can be denoted as DH, BL, R0, R1, R2, R3, and R4. In one embodiment, a set of hard read retry entries includes the respective read biases DH, BL, R0, R1, R2, R3, and R4 for each entry. The number of hard read retry entries can be arbitrary. The data-reading algorithm of the present disclosure is not limited to any specific number of hard read retry entries. The data-reading algorithm in one embodiment includes:
1. When the 1st read is able to successfully decode, nothing changes to the read biases in the set of hard read retry entries.
2. When the 1st read fails to successfully decode, subsequent read retries to decode the page are made until (in this example) the (i+3)-th read is made (which FIG. 9 denotes was successfully decoded). In one embodiment, the checksums of all failed reads are recorded as csDH, csBH, csR0, csR1, . . . csRi. Typical values of the checksums are shown on FIG. 9. Each of the checksums is associated with one of the read biases DH, BL, R0, R1, . . . Ri. If the (i+3)-th read is a soft read, then all prior hard reads failed.
3. After the soft read, the first read retry entry is replaced by the successful read's read bias. In one embodiment, the remaining entries in the hard read retry (HRR) list will be reordered according to the checksum so that earlier entries in the set of HRR entries will have lower checksums than latter entries in the set of hard read retry entries.
4. If the soft read bias, which is found by a Vt optimization algorithm (such as soft read/decoding) is different than all existing entries in the HRR list noted above, in one embodiment, the hard read entry with the largest checksum will be removed (evicted) and the soft read bias found by Vt optimization is added so that the same number of entries (7 entries) for hard read retry are retained.

FIG. 9 shows an example on the left side where the 1st and 2nd reads (i.e., 1st and 2nd hard reads (HR)) fail, and the 3rd read is successful. In this example, the memory controller (such as for example control component 120 or control circuit 220 of FIG. 2) after the 3rd read, updates the read retry entries. In one embodiment, as shown on the right side of FIG. 9, the memory controller can place the read bias of the 3rd read retry which was a success at the first position (the initial position) of a set of hard read retry entries with respective read biases for each entry. The memory controller can then place the read bias of the second read at 2nd read position, and the memory controller can move the read bias of the first read to the 3rd read position because the original first read on the left side had a higher checksum (CS) (e.g., 1500) than the original second read (e.g., 1200) on the left side. This process as shown on the right side of FIG. 9 does not evict any of the hard read retry entries. Rather, the hard read retry entries are merely reordered so that the better entries are moved to the top of the set of HRR entries.

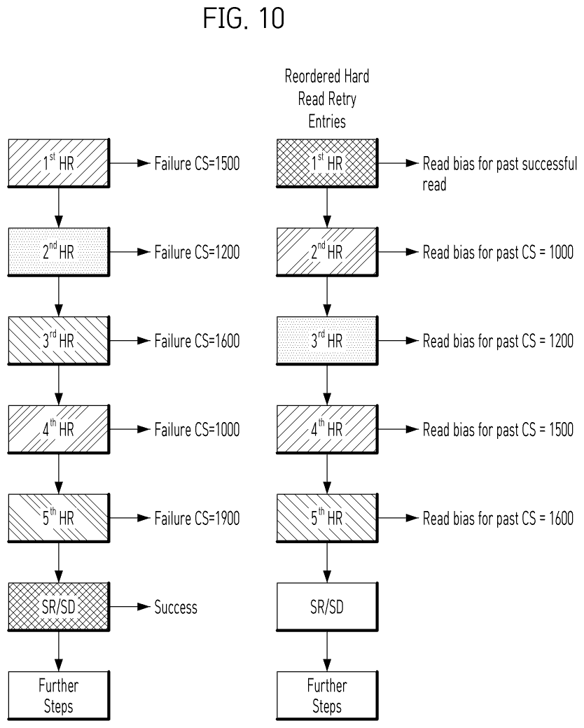

FIG. 10 shows another example where (in this embodiment) a hard read retry entry is evicted.

For simplicity, the data-reading algorithm is reactive meaning that only when there is a first read failure will the algorithm be triggered. No additional read will be needed, and no background tracking is needed, eliminating complications associated with firmware implementation and debugging of the firmware for policies requiring additional reads and background tracking.

As shown in FIG. 10 on the left side, the first five hard reads fail, and the checksums for the failed hard reads are recorded (along with the read biases). After the fifth hard read, the data-reading algorithm uses the above noted Vt optimization algorithm to find an optimal read bias. The set of hard read retry entries are reordered as shown on the right side of FIG. 10 to where the first HRR entry at the top position has the read bias found by the optimization, the other entries are re-arranged according to the checksum order noted on the left side (and noted on the right side as “past CS”), and the initial fifth HRR entry (on the right side) whose read bias had a checksum of 1900 was deleted from the set of hard read retry entries on the right side such that none of the hard read retry entries on the right side had a past CS of 1900.

In another embodiment, similar to that noted above, there may be a scenario in reading the data where some of the read bias entries in the hard read retry table (forming the set of hard read retry entries with respective read biases for each entry) are effective, but others are highly ineffective and would likely never succeed at successfully reading the data. In this embodiment, when all the effective entries fail to decode, there can be a newly found optimal bias found from the soft decoding operation, and this read-bias entry can be placed at the top of the set of HRR entries, and the last hard read entry (e.g., having the highest checksum) is evicted. Accordingly, in one embodiment of the present disclosure, the data-reading algorithm is robust in that it is able to update the entries according to any shift of the program-voltage (PV) distribution of the NAND pages.

When the data-reading algorithm is managed per block, there is another scenario in reading the data that different pages in a memory block may have different (and divergent) optimal biases. Under this circumstance, the data-reading algorithm in one embodiment can end up finding and maintaining at least two effective entries to the list. When the divergence becomes larger and one entry is no longer able to decode the pages from one page subset, while the other effective entry is able to decode, the second effective entry will be used to read another page subset, and first effective entry will be replaced, for example by the second effective entry.

In another embodiment, the data-reading algorithm can detect a scenario in reading the data where frequently first and second read biases are alternating. If this is detected, then the data algorithm may reclaim/recycle the block where this is occurring, especially if the divergence is due to a stress condition or because the block is defective. In that case, the memory controller may no longer use this defective block for storing data.

In another embodiment, when the checksum values of the failed hard reads are same (or very close for example within 5% of the average checksum value), which is usually the case when the hard read is biased and the checksum value is in a saturated region (for example a region having a checksum value greater than 2500 which typically does not increase significantly even with more errors appearing in the decoding), then the hard read retry entries can be randomly reordered. In another embodiment, the hard read retry entries can be reordered according to a distance to an updated optimal read biases. In this embodiment, to determine whether two different read biases are close, any distance metric like am Euclidian distance or weighted Euclidian distance can be applied between two different read biases.

### Alternative Update Policy

In the above data-reading algorithm, when all the hard reads fail, the optimal read biases found by the Vt optimal algorithms becomes the first hard read entry, and the hard read entry with the largest checksum can be removed. The following update policies to handle the case when all hard reads fail can be used.

Option 1: The optimal read biases found by the Vt optimal algorithm will become the first hard read entry, and the hard read entry with the largest distance to the updated optimal read biases will be removed.

Option 2: In this embodiment, the optimal read biases found by the Vt opt algorithm and the initial set of 1st HRR can be used, 2nd HRR, 3rd HRR, . . . 7th HRR to update all the hard read entries can be used.

In one embodiment, the optimal read biases replace initial 1st HRR, and shift initial 2nd HRR, 3rd HRR, . . . , 7th HRR according to the direction from the initial 1st HRR to the optimal read biases. The logic behind is that for the initial NAND threshold voltage read condition, the initial 1st HRR is optimal (or near optimal), which can be considered as the center of the NAND program-voltage distributions. The initial 2nd HRR, 3rd HRR, . . . 7th HRR surrounding the initial 1st HRR is designed accommodate for possible Vt shifts, which should provide coverage in all possible shift directions. When all the hard reads fail, it means that the center is way off the underlying set of Vt distributions, and the center (initial 1st HRR) should be updated as well as its surrounding satellites (the initial 2nd HRR, 3rd HRR, . . . , 7th HRR). After the update, in one embodiment, the new set of 1st HRR, 2nd HRR, 3rd HRR, . . . , 7th HRR will be a shifted version of the initial 1st HRR, 2nd HRR, 3rd HRR, . . . , 7th HRR. This technique permits for generation of a new underlying Vt distribution of the NAND program-voltage distributions.

### Use of Window-Averaged Checksum to Reorder the Hard Read Entries

For further improvement to the hard read entries reordering reliability, a window-averaged checksum can be as the checksum metric. For example, for each entry in the read retry (RR) table, the memory controller 100 can calculate the average checksum on for example the past 10 read biases used to read the data and the resultant checksums, no matter if the RR entry succeed or failed the decoding. When the algorithm needs to reorder the RR entries, it uses the window-averaged checksum as the metric.

When a new entry is added to the history read retry table, the memory controller 100 in this embodiment can calculate the averaged checksum, as the sum of the checksum divided by the number of times that a read bias is used (triggered) to read data from the memory. When the new entry has been triggered 10 times, the memory controller can switch to a window-average calculation, by considering only its past 10 checksums in the averaging.

In one embodiment, this method can be used when all RR failed and the checksums from all RR are similar. Also, this method can reduce the switching of the first and second entry for a block with diverging optimal biases.

In one embodiment, the number of reads in the window-average calculation can be set to different values based on the designed behavior (for example, the hard read retry entry reorder frequency). When the number is set to a small value, the reordering of the entries happens more frequently, especially when the word lines in a block have diverging optimal read biases. When the number is set to a large value, the reordering happens less frequently.

In one embodiment, separate RR tables are provided for each block, and for each RR entry in the RR table, only one window-averaged checksum needs to be stored.

### Operational Methods

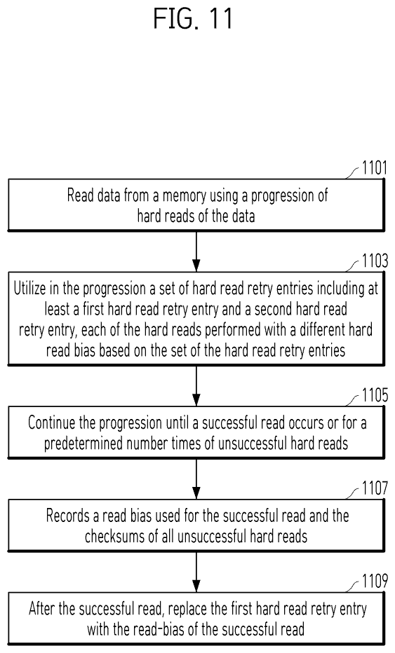

FIG. 11 is a flowchart depicting a method for operating a memory controller in accordance with one embodiment of the present invention. As illustrated in FIG. 11, at 1101, the method reads data from the memory using a progression of hard reads of the data. At 1103, the method utilizes in the progression a set of hard read retry entries including at least a first hard read retry entry and a second hard read retry entry, each of the hard reads performed with a different hard read bias based on the set of the hard read retry entries. At 1105, the method continues the progression until a successful read occurs or for a predetermined number times of unsuccessful hard reads. At 1107, the method records a read bias used for the successful read and the checksums of all unsuccessful hard reads. At 1109, the method, after the successful read, replaces the first hard read retry entry with the read-bias of the successful read.

In one aspect of this method, after the successful read, the set of hard read retry entries is reordered in an ascending order according to a magnitude of the checksums.

In one aspect of this method, the checksums for each page of the data read are averaged to obtain an averaged checksum.

In one aspect of this method, averaging averaging for each page of the data read, for a predetermined number of past reads, to obtain a windowed averaged checksum for each page of the data read.

In one aspect of this method, if all the hard reads up to the predetermined number times are unsuccessful, soft reading the data using a voltage threshold optimization is used to obtain the successful read.

In one aspect of this method, the soft reading obtains a center read bias of a program-voltage distribution for each NAND page as an optimal read bias, and the optimal read bias is used to update the set of hard read retry entries according to a shift of the program-voltage distribution of the NAND page.

In one aspect of this method, the optimal read bias found by the voltage threshold optimization becomes the first hard read entry, and the hard read entry with a largest distance to the optimal read bias is removed from the set of hard read retry entries.

In one aspect of this method, all the hard read entries in the set of hard read retry entries are updated by replacing the first hard read entry with the optimal read bias and shifting at least the second hard read entry in a direction toward the optimal read biases.

In one aspect of this method, if the read-bias of the successful soft read is different than all existing hard read retry entries, the hard read retry entry from the set of hard read retry entries that has the largest checksum is removed.

In one aspect of this method, the data for different blocks of the memory are read, and effective entries in the set of hard read retry entries which successfully read the different blocks are identified.

### Memory System

In the present invention, there is provided a memory system comprising a memory device, a controller in communication with and configured to control the memory device. The controller is configured to read data from the memory using a progression of hard reads of the data; utilize in the progression a set of hard read retry entries including at least a first hard read retry entry and a second hard read retry entry, each of the hard reads performed with a different hard read bias based on the set of the hard read retry entries; continue the progression until a successful read occurs or for a predetermined number times of unsuccessful hard reads; record a read bias used for the successful read and checksums of all unsuccessful hard reads; and after the successful read, replace the first hard read retry entry with the read-bias of the successful read.

In one aspect of this system, the controller, after the successful read, is configured to reorder the set of hard read retry entries in an ascending order according to a magnitude of the checksums.

In one aspect of this system, the controller is configured to average the checksums for each page of the data read to obtain an averaged checksum.

In one aspect of this system, the controller is configured to average for each page of the data read, for a predetermined number of past reads, the checksums to obtain a windowed averaged checksum.

In one aspect of this system, the controller is configured to, if all the hard reads up to the predetermined number times are unsuccessful, soft read the data using a voltage threshold optimization to obtain the successful read.

In one aspect of this system, the controller is configured to obtain a center read bias of a program-voltage distribution for each NAND page as an optimal read bias; and use the optimal read bias to update the set of hard read retry entries according to a shift of the program-voltage distribution of the NAND page.

In one aspect of this system, the controller is configured to use the optimal read bias as the first hard read entry, and remove from the set of hard read retry entries the hard read entry with a largest distance to the optimal read bias.

In one aspect of this system, the controller is configured to update all the hard read entries in the set of hard read retry entries by replacing the first hard read entry with the optimal read bias and shift at least the second hard read entry in a direction toward the optimal read biases.

In one aspect of this system, the controller is configured to, if the read-bias of the successful soft read is different than all existing hard read retry entries, remove the hard read retry entry from the set of hard read retry entries that has the largest checksum.

In one aspect of this system, the controller is configured to read the data for different blocks of the memory and identify effective entries in the set of hard read retry entries which successfully read the different blocks.

Although the foregoing embodiments have been described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive.

What is claimed is:

1. A method for operating a memory controller, comprising:
reading data from the memory using a progression of hard reads of the data;
utilizing in the progression a set of hard read retry entries including at least a first hard read retry entry and a second hard read retry entry, each of the hard reads performed with a different hard read bias based on the set of the hard read retry entries;
continuing the progression until a successful read occurs or for a predetermined number times of unsuccessful hard reads;
recording a read bias used for the successful read and checksums of all unsuccessful hard reads; and
after the successful read, replacing the first hard read retry entry with the read-bias of the successful read.

2. The method of claim 1, further comprising after the successful read, reordering the set of hard read retry entries in an ascending order according to a magnitude of the checksums.

3. The method of claim 2, further comprising averaging the checksums for each page of the data read to obtain an averaged checksum.

4. The method of claim 2, further comprising averaging for each page of the data read, for a predetermined number of past reads, the checksums to obtain a windowed averaged checksum.

5. The method of claim 1, further comprising:
when all the hard reads up to the predetermined number times are unsuccessful, soft reading the data using a voltage threshold optimization to obtain the successful read.

6. The method of claim 5, wherein the soft reading obtains a center read bias of a program-voltage distribution for each NAND page as an optimal read bias, and
the optimal read bias is used to update the set of hard read retry entries according to a shift of the program-voltage distribution of the NAND page.

7. The method of claim 5, wherein the optimal read bias found by the voltage threshold optimization becomes the first hard read entry, and
the hard read entry with a largest distance to the optimal read bias is removed from the set of hard read retry entries.

8. The method of claim 5, further comprising updating all the hard read entries in the set of hard read retry entries by replacing the first hard read entry with the optimal read bias and shifting at least the second hard read entry in a direction toward the optimal read biases.

9. The method of claim 1, further comprising:
when the read-bias of the successful soft read is different from all existing hard read retry entries, removing the hard read retry entry from the set of hard read retry entries that has the largest checksum.

10. The method of claim 1, wherein the reading of the data from the memory comprises reading the data for different blocks of the memory and identifying effective entries in the set of hard read retry entries which successfully read the different blocks.

11. A memory system comprising:
a memory device; and
a controller in communication with and configured to control the memory device, wherein the controller is configured to:
read data from the memory using a progression of hard reads of the data;
utilize in the progression a set of hard read retry entries including at least a first hard read retry entry and a second hard read retry entry, each of the hard reads performed with a different hard read bias based on the set of the hard read retry entries;
continue the progression until a successful read occurs or for a predetermined number times of unsuccessful hard reads;
recording a read bias used for the successful read and checksums of all unsuccessful hard reads; and
after the successful read, replacing the first hard read retry entry with the read-bias of the successful read.

12. The memory system of claim 11, wherein the controller, after the successful read, is configured to reorder the set of hard read retry entries in an ascending order according to a magnitude of the checksums.

13. The memory system of claim 12, wherein the controller is configured to average the checksums for each page of the data read to obtain an averaged checksum.

14. The memory system of claim 12, wherein the controller is configured to average for each page of the data read, for a predetermined number of past reads, the checksums to obtain a windowed averaged checksum.

15. The memory system of claim 11, wherein the controller is configured to, if all the hard reads up to the predetermined number times are unsuccessful, soft read the data using a voltage threshold optimization to obtain the successful read.

16. The memory system of claim 15, wherein the controller is configured to:
obtain a center read bias of a program-voltage distribution for each NAND page as an optimal read bias; and
use the optimal read bias to update the set of hard read retry entries according to a shift of the program-voltage distribution of the NAND page.

17. The memory system of claim 15, wherein the controller is configured to use the optimal read bias as the first hard read entry, and remove from the set of hard read retry entries the hard read entry with a largest distance to the optimal read bias.

18. The memory system of claim 15, wherein the controller is configured to update all the hard read entries in the set of hard read retry entries by replacing the first hard read entry with the optimal read bias and shift at least the second hard read entry in a direction toward the optimal read biases.

19. The memory system of claim 11, wherein the controller is configured to, when the read-bias of the successful soft read is different than all existing hard read retry entries, remove the hard read retry entry from the set of hard read retry entries that has the largest checksum.

20. The memory system of claim 11, wherein the controller is configured to read the data for different blocks of the memory and identify effective entries in the set of hard read retry entries which successfully read the different blocks.
